(19) United States
(12) Patent Application Publication
(10) Pub. No.: US 2014/0318060 A1
(43) Pub. Date: Oct. 30, 2014

(54) WIND TURBINE WITH CIRCUMFERENTIAL AIR GUIDING TOWER WALL REINFORCEMENT

(71) Applicant: Alexander Tschirch, Bremerhaven (DE)

(72) Inventor: Alexander Tschirch, Bremerhaven (DE)

(73) Assignee: AREVA Wind GmbH, Bremerhaven (DE)

(21) Appl. No.: 14/343,835

(22) PCT Filed: Sep. 6, 2012
(86) PCT No.: PCT/EP2012/067376

§ 371 Date: May 21, 2014

(30) Foreign Application Priority Data
Sep. 9, 2011 (EP) 11180805.1

(51) Int. Cl. H02K 9/02; E04H 12/00; E04B 1/92; F03D 11/04

(52) U.S. Cl. CPC H02K 9/02; F03D 11/04; E04H 12/00; E04B 1/92
USPC 52/302.5

(57) ABSTRACT

A wind turbine tower is provided. The wind turbine includes a tower wall, at least one inlet formed in a section of the tower wall for introducing air surrounding the wind turbine tower into the wind turbine tower, and a tower wall reinforcement, the tower wall reinforcement bracing the inner circumference of said tower wall section, and the tower wall reinforcement defining an air duct for guiding the air along the inner circumference of said tower wall section.

During operation, wind turbines convert the kinetic energy of the wind into electric energy. This energy conversion is accompanied by heat losses in the various components of the wind turbine. The generated heat needs to be dissipated in order to prevent damage to the wind turbine.

### BACKGROUND

Document WO 2010/069954 A1 describes a wind turbine with a closed air cooling circuit. Outside air is kept from entering the wind turbine to protect the electric equipment against salt and humidity. The wind turbine is divided by a number of platforms. A pipeline leads air between the upper and lower part of the wind turbine.

Another known solution for heat dissipation is based on a wind turbine tower comprising a tower wall, at least one inlet formed in a section of the tower wall for introducing air surrounding the wind turbine tower into the wind turbine tower, and a tower wall reinforcement.

In this solution, cool outside air surrounding the wind turbine tower is drawn into the tower via the inlets formed in the tower wall. The cool air can then take up the excess heat. For this solution to work, it must in particular meet two conditions.

The first condition is that a large volume of outside air must be drawn into the tower to ensure sufficient cooling. Consequently, large inlets are needed, which jeopardise the static stability of the tower. Typically, stability of the tower is maintained with inlet reinforcements, namely frames lining the walls of the inlets. The framing of the inlets is however not a satisfactory solution because it is complex, expensive and time consuming. In addition, the number of inlets that can be formed into the tower is limited. Indeed, because of the heat input during the welding of the frames a minimum distance between each inlet is required.

The second condition is an effective intake and distribution of the cool outside air inside the tower so that the cool air can absorb the generated heat.

### SUMMARY OF THE INVENTION

An object of the present invention is therefore to provide a stable wind turbine tower capable of an effective intake and distribution of outside air, while being at the same time easy, cheap and quick to build.

This object is achieved by a wind turbine tower as introduced above, characterised in that the tower wall reinforcement braces the inner circumference of said tower wall section, and in that the tower wall reinforcement defines an air duct for guiding the air along the inner circumference of said tower wall section.

By providing a tower wall reinforcement that braces the inner circumference of the tower wall section having the at least one air introducing inlet, the stability of the wind turbine tower is maintained despite the weakness introduced by the one or more inlets. Hence, there is no need to frame each inlet, which makes the tower easier to build.

Thanks to the air duct defined by the tower wall reinforcement, which air duct guides the air along the inner circumference of the tower wall section, the air is effectively distributed inside the tower.

According to preferred embodiments, the wind turbine tower of the invention has one or several of the following features, taken in isolation or in all technically possible combinations:
the tower wall reinforcement comprises one or more reinforcement plates inserted into the tower, wherein the edge of the or each reinforcement plate follows the inner circumference of said tower wall section;
the surface of the or each reinforcement plate is substantially at right angles to the longitudinal axis of the wind turbine tower;
the tower wall reinforcement comprises an upper reinforcement plate located above the or each inlet and a lower reinforcement plate located below the or each inlet;
the reinforcement plates are in the number of 2;
the tower wall reinforcement comprises a preferably cylindrical connecting member connecting the upper reinforcement plate to the lower reinforcement plate;
the connecting member acts as an air guide;
the air duct surrounds said air guiding connecting member and is located between the upper and lower reinforcement plate;
the air guiding connecting member includes an air vent in fluid communication with the air duct, said air vent being an outlet for the air circulating in the air duct;
several inlets are distributed, and preferably evenly distributed, over the circumference of the tower wall section;
the tower wall section is part of the upper third of the tower wall;
   the or each inlet is an inlet to said air duct.

The invention also relates to a wind turbine having a wind turbine tower as defined above.

### BRIEF SUMMARY OF THE DRAWINGS

The invention will be better understood when reading the following description of a non limiting example of the invention, with reference to the accompanying figures, wherein

FIG. 1 is a longitudinal section through a preferred embodiment of a wind turbine tower according to the invention; and

FIG. 2 is a cross section according to arrows II of FIG. 1.

### DETAILED DESCRIPTION

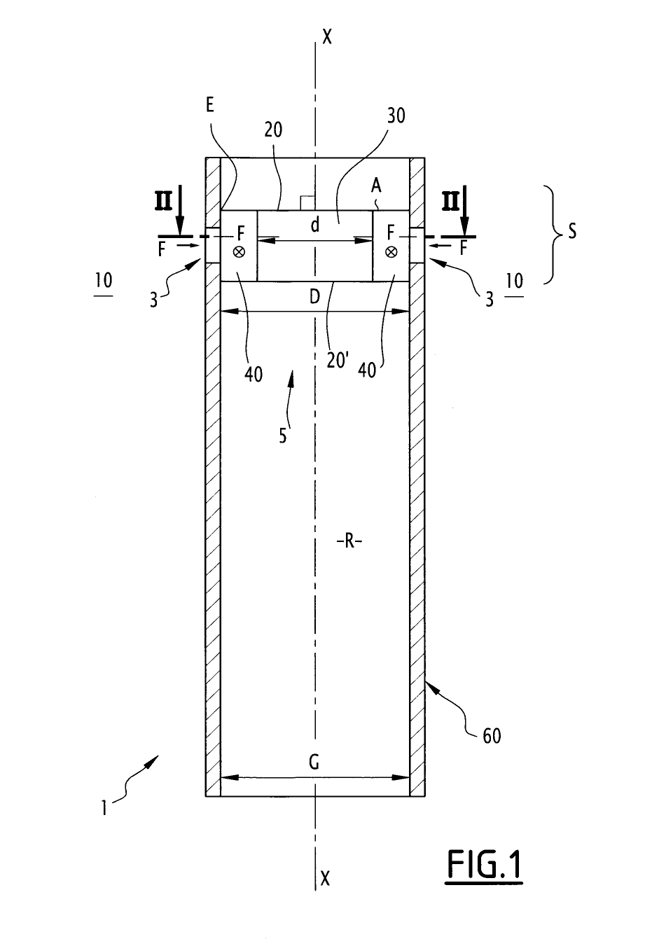

With reference to FIG. 1, there is shown a longitudinal section of a wind turbine tower 1. The air surrounding the tower 1 has the reference number 10. The longitudinal axis of the tower 1 is indicated by the dashed line X-X. The wind turbine tower 1 includes a tower wall 60 and has an inner diameter G. The tower wall 60 delimits an inside space R of the tower 1. The tower wall 60 has a section S into which several air inlets 3 are formed. Preferably, the section S is part of the upper third of the tower wall 60.

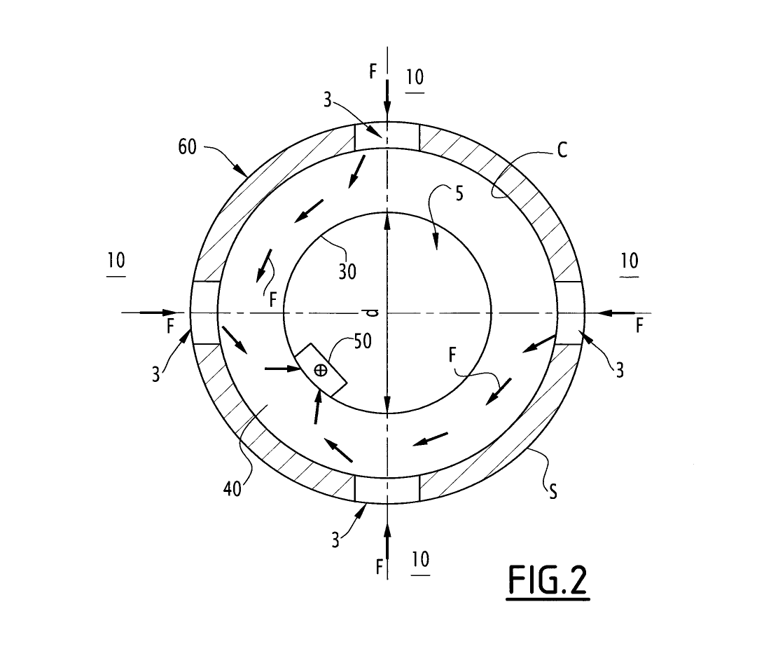

As can be seen in FIG. 2, the tower wall section S has an inner circumference C. In this exemplary embodiment, there are four oval air inlets 3 that are evenly distributed around the circumference C of the tower wall section S. However, the number, shape and distribution of the air inlets 3 might be different.

A tower wall reinforcement 5 is inserted into the tower wall section S. It braces the inner circumference C of the tower wall section S.

The tower wall reinforcement 5 comprises an upper reinforcement plate 20 located above the air inlets 3, a lower reinforcement plate 20′ located below the air inlets 3, a connecting member 30 connecting the two reinforcement plates 20, 20′, and an air vent 50 formed in the connecting member 30.

Each reinforcement plate 20, 20′ is preferably circular with a diameter D, which corresponds to the inner diameter G of tower 1. Each reinforcement plate 20, 20′ has an edge E and a surface A. The edge E of each reinforcement plate 20, 20′ follows the inner circumference C of the tower wall section S. The surface A of each reinforcement plate 20, 20′ is substantially perpendicular to the longitudinal axis X-X of the tower 1. The connecting member 30 is preferably cylindrical with a diameter d, which is smaller than the diameter D of the reinforcement plates 20, 20′.

In the present embodiment, the air vent 50 is a cut-out in the cylindrical wall of the connecting member 30.

The reinforcement plates 20, 20′, the connecting member 30 and the tower wall section S together define an annular chamber 40. The annular chamber 40 surrounds the connecting member 30 and is located between the upper and lower reinforcement plate 20, 20′. The four air inlets 3 are inlets to the annular chamber 40 and the air vent 50 is an outlet from the annular chamber 40.

The tower wall reinforcement 5 acts as an air guide for introducing the cool outside air 10 into the tower 1 in order to cool the inside space R of the tower. This air guiding effect will now be described in the case where tower 1 is an offshore wind turbine tower. Since the tower wall section S is located in the upper third of the tower 1, it is above the splash water area, meaning that the outside air 10, which is drawn into the tower 1 via the inlets 3, has a comparatively low salt and humidity content. Accordingly, the outside air 10 needs less treatment such as water separation before it can be used for cooling.

With reference to FIG. 2, the flow path of the air 10 is indicated by the arrows F. Thanks to the circular geometry, there is a uniform air flow from the outside into the inlets 3. The outside air 10 is sucked into the tower wall section S via the inlets 3 and enters the annular chamber 40. The annular chamber 40 acts as an air duct and the connecting member 30 acts as an air guide, such that the air is guided along the inner circumference C of the tower wall section S towards the outlet 50. The air leaves the air duct 40 through the outlet 50 towards the bottom of the tower 1 to be further distributed.

As apparent from the above, embodiments of the present invention are in particular based on the idea of using the tower wall reinforcement not only for reinforcing the tower but also for guiding the cooling air in a controlled manner.

Thanks to the reinforcement plates 20, 20′ that act as stiffening rings, no framing of the inlets 3 is needed.

Since the air vent 50 is formed in the connecting member 30, the air vent 50 can be designed at will without any effect on the stability of the tower 1, and without any need to modify the arrangement of the inlets 3. Thanks to the direct coupling of the tower wall reinforcement with the tower wall 60 one obtains a hermetic separation between the incoming air and the inside air.

Also, thanks to the dual use of the tower wall reinforcement 5 as a framing and as an air guide, no extra space must be provided for the air duct 40. Indeed, the latter is already included in the tower wall reinforcement 5.

What is claimed is:

1-13. (canceled)

14. A wind turbine tower comprising:
a tower wall;
at least one inlet formed in a section of the tower wall for introducing air surrounding the wind turbine tower into the wind turbine tower; and
a tower wall reinforcement bracing an inner circumference of the tower wall section, the tower wall reinforcement defining an air duct for guiding the air along the inner circumference of the tower wall section.

15. The wind turbine tower as recited in claim 14 wherein the tower wall reinforcement includes one or more reinforcement plates inserted into the tower, an edge of the or each reinforcement plate following the inner circumference of the tower wall section.

16. The wind turbine tower as recited in claim 15 wherein a surface of the or each reinforcement plate is substantially at a right angle to a longitudinal axis of the wind turbine tower.

17. The wind turbine tower as recited in claim 14 wherein the tower wall reinforcement includes an upper reinforcement plate located above the or each inlet and a lower reinforcement plate located below the or each inlet.

18. The wind turbine tower as recited in claim 17 wherein the upper and lower reinforcement plates are in the number of 2.

19. The wind turbine tower as recited in claim 17 wherein the tower wall reinforcement further includes a connector connecting the upper reinforcement plate to the lower reinforcement plate.

20. The wind turbine tower as recited in claim 19 wherein the connector is cylindrical.

21. The wind turbine tower as recited in claim 19 wherein the connector forms an air guide.

22. The wind turbine tower as recited in claim 21 wherein the air duct surrounds the air guide and is located between the upper and lower reinforcement plates.

23. The wind turbine tower as recited in claim 21 wherein the air guide includes an air vent in fluid communication with the air duct, the air vent being an outlet for the air circulating in the air duct.

24. The wind turbine tower as recited in claim 14 further comprising several inlets distributed over the circumference of the tower wall section.

25. The wind turbine tower as recited in claim 24 wherein the inlets are distributed evenly over the circumference of the tower wall section

26. The wind turbine tower as recited in claim 14 wherein the tower wall section is part of an upper third of the tower wall.

27. The wind turbine tower as recited in claim 14 wherein the or each inlet is an inlet to the air duct.

28. A wind turbine comprising the wind turbine tower as recited in claim 14.
